(19) United States
(12) Patent Application Publication
(10) Pub. No.: US 2010/0086331 A1
(43) Pub. Date: Apr. 8, 2010

(54) Exposure Head and Image Forming Device

(75) Inventors: Nozomu INOUE, Matsumoto-shi (JP); Yoshio ARAI, Shiojiri-shi (JP); Kiyoshi TSUJINO, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/573,449

(22) Filed: Oct. 5, 2009

(30) Foreign Application Priority Data
Oct. 6, 2008 (JP) 2008-259369

(51) Int. Cl. G03G 15/04

(52) U.S. Cl. 399/220

(57) ABSTRACT

An exposure head includes a substrate through which light from light-emitting elements provided on a first surface of the substrate penetrates from the first surface to a second surface. A rod lens array is provided on the second surface of the substrate to image the light from the second surface. A light transparent member is provided between the substrate and the rod lens array and fixed to the second surface of the substrate and the rod lens array. A support member supports the first surface of the substrate.

### CROSS-REFERENCE TO RELATED APPLICATIONS

This application claims the benefit of priority under 35 USC 119 of Japanese patent application no. 2008-259369, filed on Oct. 6, 2008, which is incorporated herein by reference.

### BACKGROUND

1. Technical Field

The present invention relates to an exposure head that images light from light-emitting elements onto a rod lens array and exposes an object surface, and an image forming device using the exposure head.

2. Related Art

JP-A-2006-231649 discloses an example of such an exposure head in which light from light-emitting elements formed on a glass substrate is imaged onto a rod lens array that faces the glass substrate. In the exposure head disclosed in JP-A-2006-231649, the light-emitting elements are provided on a back surface of the glass substrate, where the back surface is disposed on the opposite side of the rod lens array, out of a front surface and the back surface of the glass substrate. Accordingly, light from the light-emitting elements enters the rod lens array after passing through the glass substrate.

However, since a layer of air exists between the glass substrate and the rod lens array, some of the light from the light-emitting elements is reflected at an interface between the surface of the glass substrate and the layer of air. As a result, the intensity of light contributing to imaging is reduced and there is a possibility that an appropriate exposure cannot be performed due to insufficient light. JP-A-2007-076083 and JP-A-2006-205384 disclose techniques for suppressing the reflection of light at the surface of the glass substrate by providing a transparent material such as resin between the glass substrate and the rod lens array.

As disclosed in JP-A-2007-076083 and JP-A-2006-205384, a light permeable member (transparent material) can be fixed to both the substrate (glass substrate) and the rod lens array. However, since the rod lens array and the substrate are fixed to each other with the light permeable member interposed between them, the following problem arises. That is, if the rod lens array deforms due to a change in temperature, the substrate fixed to the rod lens array via the light permeable substrate is also deformed. Further, since light-emitting elements are provided on the substrate, if the substrate deforms, the imaging position of the light from the light-emitting elements is likely to be shifted.

### SUMMARY

An advantage of some aspects of the invention is that it provides a technique capable of achieving good exposure by suppressing the deviation of the imaging position regardless of a deformation in a rod lens array in a structure in which a substrate provided with light-emitting elements thereon and the rod lens array are fixed to each other via a light permeable member interposed between them.

According to one aspect of the invention, an exposure head is provided including a substrate through which light from light-emitting elements provided on a first surface of the substrate penetrates from the first surface to a second surface, a rod lens array provided on the second surface of the substrate to image the light from the second surface, a light permeable member provided between the substrate and the rod lens array and fixed to the second surface of the substrate and the rod lens array, and a support member that supports the first surface of the substrate.

According to another aspect of the invention, an image forming device is provided including a latent image carrier, an exposure head that includes a substrate through which light from light-emitting elements provided on a first surface of the substrate penetrates from the first surface to a second surface, a rod lens array provided on the second surface of the substrate to image the light from the second surface of the substrate onto the latent image carrier, a light permeable member provided between the substrate and the rod lens array and fixed to the second surface of the substrate and the rod lens array, a support member that supports the first surface of the substrate, and a developing unit that develops a latent image formed on the latent image carrier by the exposure head using toner.

In the exposure head and the image forming device with the above structure, the light-emitting elements are provided on the first surface of the substrate and the light from the light-emitting elements penetrate through the substrate from the first surface to the second surface. The rod lens array is provided on the second surface of the substrate and the rod lens array images the light from the second surface of the rod lens array. The light permeable member is provided between the substrate and the rod lens array and is fixed to both the second surface of the substrate and the rod lens array. Accordingly, there is a possibility that the substrate deforms if the rod lens array deforms. For this reason, the exposure head and the image forming device of the invention are equipped with the support member that supports the first surface of the substrate. Deformation of the substrate is thereby suppressed by the support member. Since deformation of the substrate is suppressed, even though the rod lens array deforms, it becomes possible to achieve a good exposure and to attain formation of a good image.

In the exposure head, the light-emitting elements are bottom emission type organic EL elements and the first surface of the substrate may be supported via a sealing member which seals the organic EL element. Due to the presence of the sealing member, it is possible to inhibit the organic EL elements from deteriorating by blocking from air.

However, in the case in which the linear expansion ratio of the substrate is smaller than that of the rod lens array, the rod lens array expands and contracts significantly more than the substrate when the temperature varies. As a result, the force that can cause deformation is applied to the substrate from the rod lens array via the light permeable member. Accordingly, the invention suppresses deformation of the substrate in such a structure, thereby realizing the exposure in a good state.

In the exposure device, the linear expansion ratio of the support member may be larger than that of the substrate. With such a structure, the force resisting against the force applied to the substrate from the rod lens array can be transferred to the substrate from the support member. Accordingly, it becomes possible to attain good exposure by reliably suppressing deformation of the substrate.

In the exposure head, the linear expansion ratio of the rod lens array may be equal to or substantially equal to that of the support member. With such a structure, it is possible to balance the force applied to the substrate from the rod lens array and the force applied to the substrate from the support member so as to resist against the former force.

In the exposure device, the support member may be configured to include a flat surface portion supporting the second surface of the substrate and a curve portion curved to start from the ends of the flat surface portion. With such a structure, the rigidity of the support member is improved and it is advantageous in achieving good exposure due to the suppressing of the deformation of the substrate.

### BRIEF DESCRIPTION OF THE DRAWINGS

The invention will be described with reference to the accompanying drawings, wherein like numbers reference like elements.

FIG. 1 is a view illustrating an image forming device according to an embodiment of the invention.

FIG. 2 is a view illustrating an electrical structure of the image forming device of FIG. 1.

FIG. 3 is a partial perspective view illustrating a structure of a line head.

FIG. 4 is a partial sectional view illustrating the line head in a lateral direction.

FIG. 5 is a partial plan view illustrating a structure of a back surface of a head substrate provided with the line head.

FIG. 6 is a view showing an optical characteristic of a rod lens array.

FIG. 7 is a view showing an optical characteristic of a line head that is not equipped with a glass substrate.

FIG. 8 is a view showing an optical characteristic of a line head that is equipped with a glass substrate.

FIG. 9 is an explanatory view for explaining the advantageous effect of the invention.

FIG. 10 is a lateral direction partial sectional view illustrating a light-emitting diode (LED) used as a light-emitting element.

### DESCRIPTION OF EXEMPLARY EMBODIMENTS

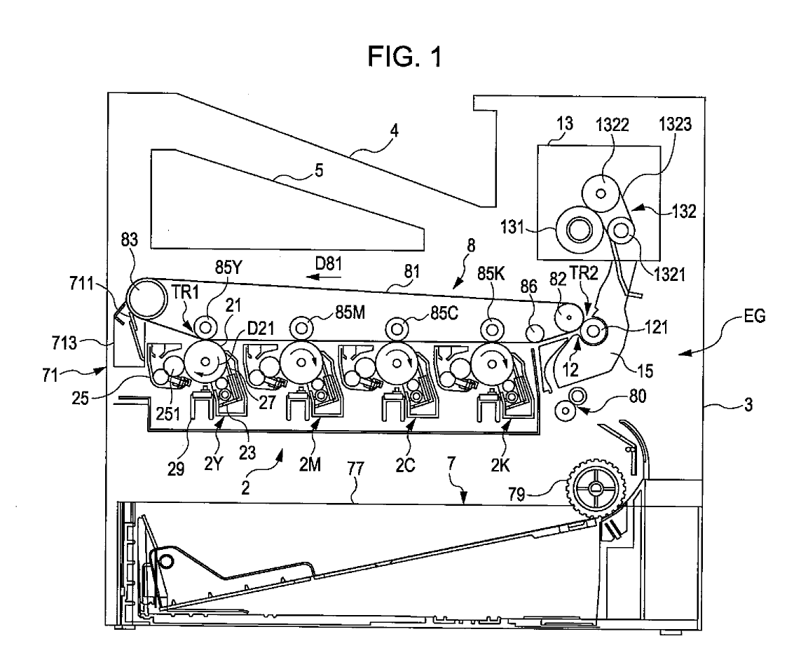

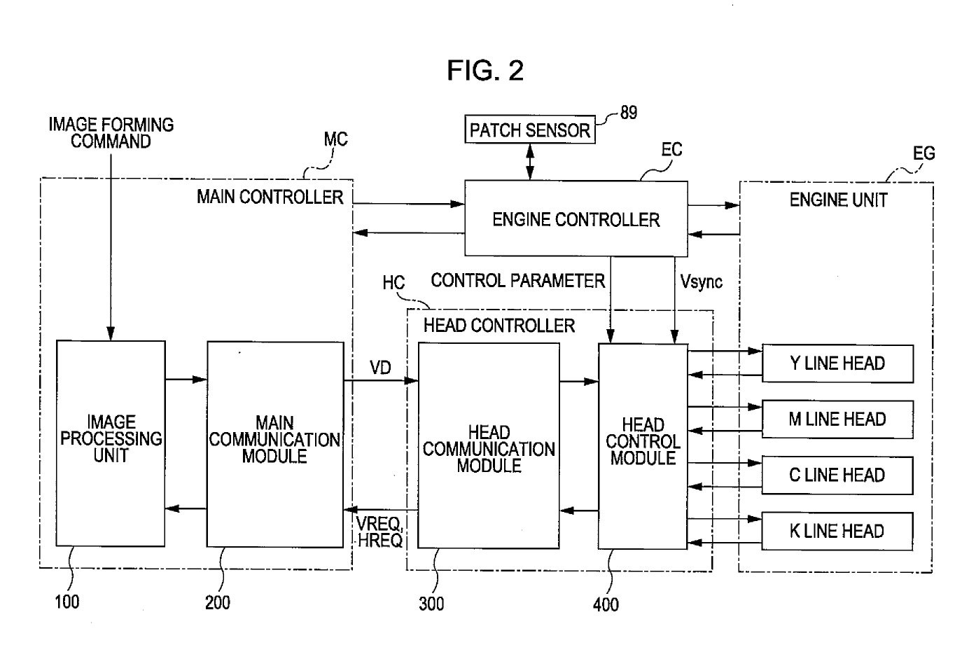

FIG. 1 is a view illustrating an image forming device according to an embodiment of the invention. FIG. 2 is a view illustrating an electrical structure of the image forming device of FIG. 1. The image forming device selectively performs a color mode in which a color image is formed by layering four colors of toner including yellow Y, magenta M, cyan C, and black K in an overlapping manner, and a monochrome mode in which a monochrome image is formed with only a single color of toner, a black color toner K. In the image forming device, when an image forming command is given to a main controller MC having a CPU and a memory using an external device such as a host computer, the main controller MC sends a control signal to an engine controller EC and the engine controller EC performs a predetermined image forming operation by controlling each of the parts of the image forming device, such as an engine unit EG and a head controller HC of the device on the basis of the control signal and forms an image corresponding to the image forming command on a sheet that is a recording medium, such as copying paper, transfer paper, paper, and transparent sheet for an over head projector (OHP).

An electric component box 5 in which a power supply circuit board, a main controller MC, an engine controller EC, and a head controller HC are embedded is provided inside a housing 3 of the image forming device. An image forming unit 2, a transfer belt unit 8, and a paper supplying unit 7 are also provided in the housing 3. A secondary transfer unit 12, a fixing unit 13, and a sheet guide member 15 are provided on the right side of the housing 3 in FIG. 1. The paper supplying unit 7 is freely detachable from the housing 3. The paper supplying unit 7 and the transfer belt unit 8 are structured such that they can be detached so as to be able to be repaired and replaced.

The image forming unit 2 includes four image forming stations 2Y (for yellow), 2M (for magenta), 2C (for cyan), and 2K (for black) for forming different colors of images. In FIG. 1, since the image forming stations of the image forming unit 2 have the same structure, only one of the image forming stations is referenced with numbers and reference numbers for other image forming stations are omitted for convenience sake.

Each of the image forming stations 2Y, 2M, 2C, and 2K is provided with a photoconductor drum 21 having a surface on which a toner image of each color is formed. A rotary shaft of each of the photoconductor drums 21 is disposed to be parallel or almost parallel with a main scanning direction MD (a direction perpendicular to the paper surface of FIG. 1). Each of the photoconductor drums 21 is connected to its own drive motor and rotationally driven in the direction of arrow D21 in the figure at a predetermined speed. The surface of the photoconductor drum 21 is moved in a sub-scanning direction SD that perpendicularly or almost perpendicularly intersects the main scanning direction MD. A charging unit 23, a line head 29, a developing unit 25, and a photoconductor cleaner 27 are provided around the photoconductor drum 21 in the rotating direction. A charging operation, a latent image forming operation, and a toner developing operation are performed by these functional units. When the color mode is performed, toner images formed by all of the image forming stations 2Y, 2M, 2C, and 2K are transferred to the transfer belt 81 provided in the transfer belt unit 8 in an overlapping manner, so that a color image is formed. When the monochrome mode is performed, only the image forming station 2K operates so as to form a black (single color) image.

The charging unit 23 includes a charging roller whose surface is made of rubber. The charging roller is structured such that it is in contact with the surface of the photoconductor drum 21 at a charging position and thus is rotated along with the rotary motion of the photoconductor drum 21. The charging roller is connected to a charging bias generating unit (not shown). The charging roller receives a charging bias from the charging bias generating unit and charges the surface of the photoconductor drum 21 up to a surface potential at the charging position where the charging unit 23 is in contact with the photoconductor drum 21.

The line head 29 is disposed such that the longitudinal direction LGD of the line head 29 is parallel or almost parallel with the main scanning direction MD, and the lateral direction LTD of the line head 29 is parallel or almost parallel with the sub-scanning direction SD. The line head 29, which is provided with a plurality of the light-emitting elements arranged in the longitudinal direction LGD, is disposed to face the photo conductor drum 21. Thus an electrostatic latent image is formed on the surface of the photoconductor drum 21 that has been charged by the charging unit 23 by imaging light from the light-emitting elements.

The developing unit 25 has a developing roller 251 that carries toner on the surface thereof. The charged toner is moved to the photoconductor drum 21 from the developing roller 251 at the developing position where the developing roller 251 and the photoconductor drum 21 are in contact with each other due to the developing bias applied to the developing roller 251 from the developing bias generating unit (not shown) that is electrically connected to the developing roller 251, and the electrostatic latent image formed on the surface thereof is turned into a visible image.

The toner image that has become a visible image at the developing position is transported in the rotating direction D21 of the photoconductor drum 21, and is then primarily transferred to the transfer belt 81 at a primary transfer position TR1 at which the transfer belt 81 and each of the photoconductor drums 21 are in contact with each other.

At a downstream side of the primary transfer position TR1 and an upstream side of the charging unit 23 in the rotating direction D21 of the photoconductor drum 21, a photoconductor cleaner 27 is provided in a manner such that it is in contact with the surface of the photoconductor drum 21. The photoconductor cleaner 27 cleans the surface of the photoconductor drums 21 by removing toner remaining on the surfaces of the photoconductor drums 21 by abutting against the surfaces of the photoconductor drums 21 after the primary transfer.

The transfer belt unit 8 includes a driving roller 82, a driven roller 83 (blade-facing roller) provided on the left side of the driving roller 82 in FIG. 1 and a transfer belt 81 stretched between these rollers. The transfer belt 81 circulates in the direction of arrow D81 in the drawings (transporting direction) along with the rotary motion of the driving roller 82. The transfer belt unit 8 includes four primary transfer rollers 85Y, 85M, 85C, and 85K placed on the inner side of the transfer belt 81 in a manner such that they respectively face the photoconductor drums 21 of the image forming stations 2Y, 2M, 2C, and 2K when a cartridge is mounted. Each of these primary transfer rollers is electrically connected to the primary transfer bias generating unit (not shown).

When the color mode is performed, the transfer belt 81 is pressed against the photoconductor drums 21 of the image forming stations 2Y, 2M, 2C, and 2K so that it is brought into contact with each of the photoconductor drums 21 of the image forming stations 2Y, 2M, 2C, and 2K 21 by positioning all of the primary transfer rollers 85Y, 85M, 85C, and 85K on the side of the image forming stations 2Y, 2M, 2C, and 2K, respectively as shown in FIGS. 1 and 2. As a result, the primary transfer position TR1 is formed between the photoconductor drums 21 and the transfer belt 81. The toner images formed on the surfaces of the photoconductor drums 21 are transferred to the surface of the transfer belt 81 at the corresponding primary transfer positions TR1 by applying a primary transfer bias from the primary transfer bias generating unit to the primary transfer rollers 85Y and so on at appropriate timing. That is, in the color mode, a toner image of each color is overlapped on the transfer belt 81 to form a color image.

Further, the transfer belt unit 8 includes a downstream guide roller 86 provided at the downstream side of the primary transfer roller 85K, which is for a black toner image, and at the upstream side of the driving roller 82. The downstream guide roller 86 is structured so as to come into contact with the transfer belt 81 on the common tangential line of the primary transfer roller 85K and the black photoconductor drum 21(K) at the primary transfer position TR1 at which the primary transfer roller 85K and the photoconductor drum 21 of the image forming station 2K are in contact with each other.

A patch sensor 89 is provided such that it faces the surface of the transfer belt 81 wound around the downstream guide roller 86. The patch sensor 89 is composed of, for example, a reflection type photo-sensor. It detects the position or the density of a patch image formed on the transfer belt 81 as required by optically detecting changes in the reflectance of the surface of the transfer belt 81.

The paper supplying unit 7 includes a paper supply unit having a paper supply cassette 77 that holds stacked sheets of paper and a pick-up roller 79 for supplying paper sheets one by one from the paper supply cassette 77. The sheets supplied by the pick-up roller 79 from the paper supplying unit are sent to a secondary transfer position TR2 at which the driving roller 82 and the secondary transfer roller 121 are in contact with each other along the sheet guide member 15 after the paper supply timing is adjusted by a pair of resist rollers 80.

The secondary transfer roller 121 is provided in a manner such that it can come into contact with and be separated from the transfer belt 81, and is driven to be in contact with and separated from the transfer belt 81 by the secondary transfer roller driving mechanism (not shown). The fixing unit 13 includes a heating roller 131 that can freely rotate and embeds a heating element such as a halogen heater therein, and a pressing portion 132 that presses and pushes the heating roller 131. The sheet with the surface to which the image is secondarily transferred is led to a nip portion formed by the heating roller 131 and a pressing belt 1323 of the pressing portion 132 by the sheet guide member 15, and the image is thermally fixed at the nip portion at a predetermined temperature. The pressing portion 132 is composed of the pressing belt 1323 stretched and wound around two rollers 1321 and 1322. The surface of the pressing belt 1323 stretched and wound around the rollers 1321 and 1322 is pressed against the circumferential surface of the heating roller 131, and the nip portion formed by the heating roller 131 and the pressing belt 1323 is widened. The sheet that has been subjected to such fixing processing is sent to a paper discharge tray 4 provided on the upper surface portion of the housing 3.

The driving roller 82 drives the transfer belt 81 to circulate in the direction of arrow D81 in FIG. 1. The driving roller 82 also functions as a back-up roller of the secondary transfer roller 121. The circumferential surface of the driving roller 82 is provided with a rubber layer with a thickness of about 3 mm and a volume resistivity of 1000 kΩ·cm or less. The driving roller 82 is grounded via a metal shaft. Accordingly, it can serve as a conductive route for the secondary transfer bias supplied via the secondary transfer roller 121 from the secondary bias generating unit (not shown). Since the driving roller 82 is provided with the rubber layer which has a high friction and shock-absorbing property, it is possible to prevent quality degradation of image due to shocks that are generated when the sheet progresses to the secondary transfer position TR2 and is transferred to the transfer belt 81.

A cleaner unit 71 faces a blade-facing roller 83. The cleaner unit 71 includes a cleaner blade 711 and a waste toner box 713. The cleaner blade 711 eliminates foreign matter such as toner or paper powder remaining on the transfer belt 81 after the secondary transfer by abutting the leading end portion thereof against the blade-facing roller 83 via the transfer belt 81. The eliminated foreign matter is withdrawn to the waste toner box 713. The cleaner blade 711 and the waste toner box 713 are formed integrally with the blade-facing roller 83.

Each of the photoconductor drums 21 of the image forming stations 2Y, 2M, 2C, and 2K, the charging unit 23, the developing unit 25, and the photoconductor cleaner 27 are formed integrally into a single unit as a cartridge. The cartridge is structured such that it can be detached from the main body of the device. Each of the cartridges is provided with a non-volatile memory for storing information about the cartridge. Wireless communication is performed between the engine controller EC and each of the cartridges. By doing this, information about each of the cartridges is sent to the engine controller EC and the information stored in each of the memories is updated. On the basis of such information, history of the use of each of the cartridges and the lifespan of expendable supplies are managed.

The main controller MC, the head controller HC, and the line heads 29 are realized in respective discrete components, and are connected to one another via serial communicable cables. Exchange of data among the components is described with reference to FIG. 2. If the image forming command is given to the main controller MC by an external device, the main controller MC sends a control signal for starting the engine unit EG to the engine controller EC. The image processing unit 100 provided in the main controller MC performs predetermined signal processing with respect to the image data contained in the image forming command and generates video data VD for each of the toner colors.

On the other hand, the engine controller EC to which the control signal is given initializes each part of the engine unit EG and starts the warming-up process. When these operations are completed and it is ready to perform the image forming operation, the engine controller EC outputs a synchronous single Vsync, which is a trigger for the start of the image forming operation, to the head controller HC that controls each of the line heads 29.

The head controller HC is provided with a head control module 400 for controlling each unit of the line head and a head-side communication module 300 for performing data communication with the main controller MC. The main controller MC is also provided with a main-side communication module 200. A vertical request signal VREQ, which indicates the front portion of an image corresponding to the amount of one page, and a horizontal request signal HREQ, which demands video data corresponding to the amount of one line out of the lines constituting the image, are sent from the head-side communication module 300 to the main-side communication module 200. Video data VD is transmitted in the direction from the main-side communication module 200 to the head-side communication module 300. In greater detail, after the main-side communication module 200 receives the vertical request signal VREQ indicating the front portion of the image, it outputs the video data VD sequentially line by line from the head portion of the image whenever it receives the horizontal request signal HREQ. Thus, each of the light-emitting elements emits light on the basis of the video data VD.

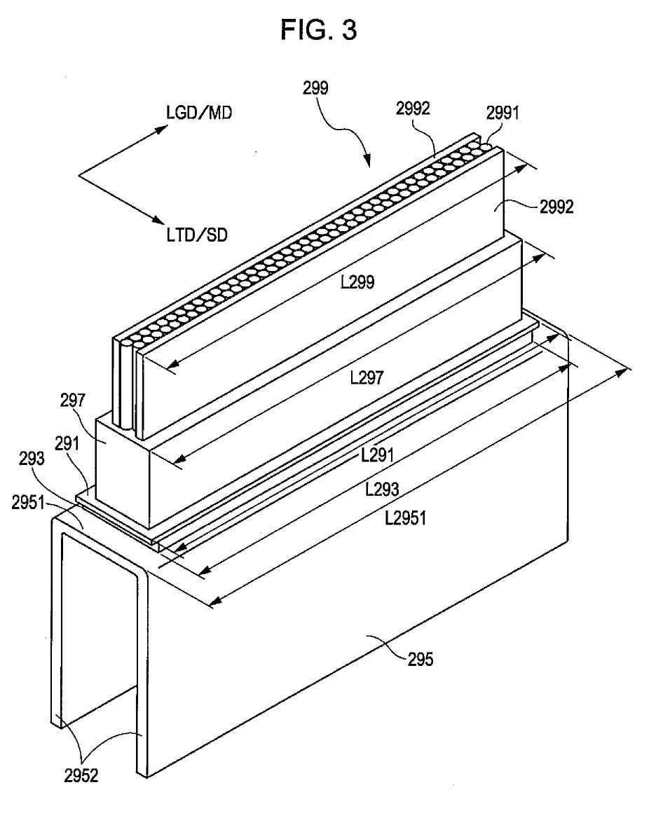

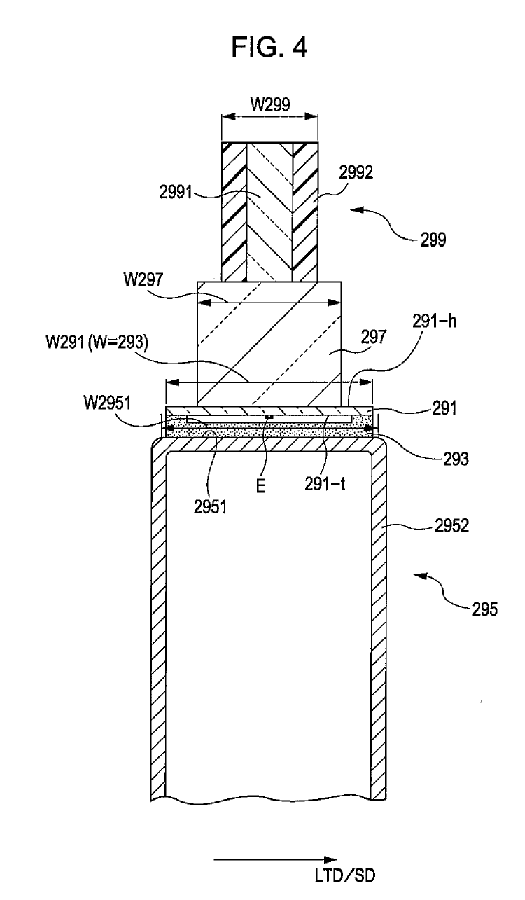

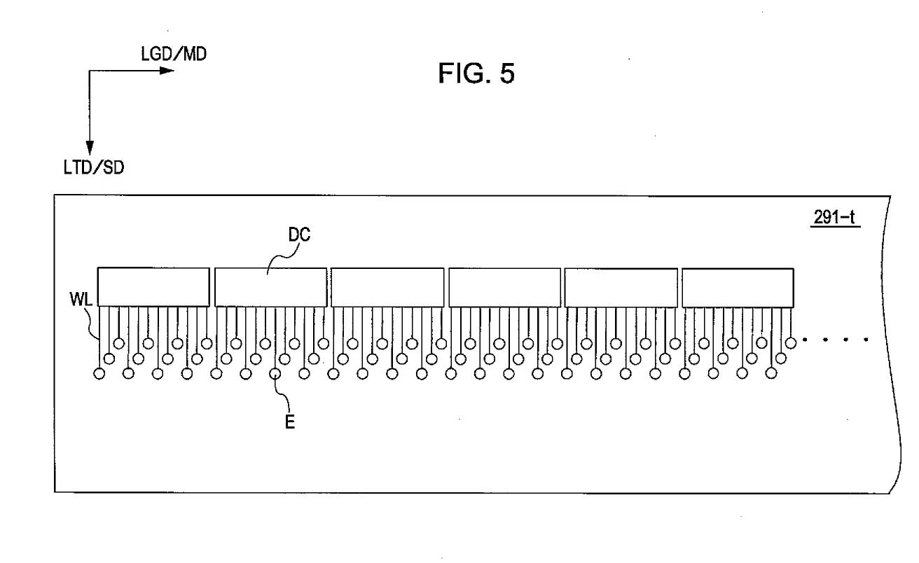

FIG. 3 is a partial perspective view illustrating a structure of the line head. FIG. 4 is a partial sectional view illustrating the line head in the lateral direction. FIG. 5 is a partial plan view illustrating a structure of the back surface of the head substrate included in the line head. The view of FIG. 5 shows the case in which the back surface 291-t is viewed from the front surface 291-h side of the head substrate 291. Since these are partial views, they don't show all of the parts of the line head 29. The structure of the line head 29 is described in detail below with reference to these figures.

The head substrate 291 provided in the line head 29 is a glass substrate in the form of a flat panel. The back surface 291-t (first surface) of the head substrate 291 is provided with a plurality of light-emitting elements E arranged in a zigzag form in three rows in the longitudinal direction LGD (FIG. 5). Each of the light-emitting elements E is a bottom emission type organic electro-luminous (EL) element. The back surface 291-t of the head substrate 291 is further provided with a drive circuit DC and each of the light-emitting elements E is connected to the drive circuit DC via wiring WL (FIG. 5). Thus, the drive circuit DC drives the light-emitting elements E according to the video data VD. The drive circuit DC can be composed of thin film transistors (TFTs). From the view point of the TFT forming process, the base material of the head substrate 291 is alkali-free glass. Further, a sealing member 293 made of glass is bonded and fixed to the back surface 291-t of the head substrate 291. Since the sealing member 293 protects the light-emitting elements E, which are organic EL elements, from the air, it is possible to prevent the light-emitting elements E from deteriorating.

A frame 295 is bonded and fixed to the back surface of the sealing member 293. The frame 295 is made of a plate (steel) that is a rigid member and has a linear expansion ratio of about 16×10⁻⁶(/° C.). The frame 295 includes a flat surface portion 2951 that is parallel or almost parallel with the lateral direction LTD and the longitudinal direction LGD, and a curve portion 2952 that is curved and starts from the ends of the flat surface portion 2951. The frame 295 is inverted U-shaped (see FIGS. 3 and 4). The flat surface portion 2951 is bonded and fixed to the back surface of the sealing member 293. As described above, in this embodiment, the back surface 291-t of the head substrate 291 is supported by the frame 295 via the sealing member 293.

A glass member 297 (light permeable member) is in contact with the front surface 291-h (second surface) of the head substrate 291. The glass member 297 has a quadrangular prism shape whose longer side is in the longitudinal direction LGD. The lower surface of the glass member 297 is bonded and fixed to the front surface 291-h of the head substrate 291 by a transparent adhesive. The transparent adhesive has the same or almost the same refractive index as the glass member 297. When bonding the glass member 297 and the head substrate 291 to each other, UV radiation is preferably not performed because there is a possibility that the light-emitting elements E will deteriorate due to the UV radiation. Accordingly, a heat and UV-curable adhesive, a heat-curable adhesive, or an anaerobic adhesive is preferably used as the adhesive. It is further preferable that the adhesive is as thin as possible because the thickness of a thin adhesive is less variable compared to that of a thick adhesive. A rod lens array 299 is provided on the front surface 291-h of the head substrate 291. The lower surface of the rod lens array 299 is in contact with the upper surface of the glass member 297.

In the rod lens array 299, a plurality of rod lenses 2991, which are stacked such that the rod lenses 2991 in a line are closely interlocking with the rod lenses 2991 in a next line, are bonded to one another by a silicon-based opaque adhesive. The rod lenses 2991 have an erected and unmagnified image forming characteristic. The plurality of rod lenses 2991 is interposed between two resin plates 2992 placed in the lateral direction LTD. A base substance of the resin plates 2992 is fiber reinforced plastics (FRP) containing glass fiber therein. The lower surface of the rod lens array 299 with the above structure is bonded and fixed to the upper surface of the glass member 297 by a transparent adhesive. The transparent adhesive is preferably made of a material that is compatible with glass, FRP, and silicon adhesive. With such a scheme, it is possible to securely bond different kinds of materials to each other. In an assembly process of the line head 29, in the case in which bonding between the glass member 297 and the rod lens array 299 is performed before the head substrate 291 and the glass member 297 are bonded to each other, there is no concern that the light-emitting elements E are deteriorated by ultraviolet(UV) rays. Accordingly, the use of the UV-curable adhesive is allowed. Further, the thickness of the adhesive is preferably as small as possible so as to reduce the variation in thickness. The transparent adhesive has the same or almost the same refractive index as the glass member 297.

A dimensional relationship among members of the line head 29 will be described below. The dimensional relationship in the longitudinal direction LGD is shown in the following expression.

L2951>L291>L293>L297>L299

Here, L2951 is a length of the flat surface portion 2951 of the frame 295, L293 is a length of the sealing member 293, L291 is a length of the head substrate 291, L297 is a length of the glass member 297, and L299 is a length of the rod lens array 299. The dimensional relationship in the lateral direction LTD is shown in the following expression.

W2951>W291=W293>W297>W299

Here W2951 is a width of the flat surface portion 2951 of the frame 295, W293 is a width of the sealing member 293, W291 is a width of the head substrate 291, W297 is a width of the glass member 297, and W299 is a width of the rod lens array 299.

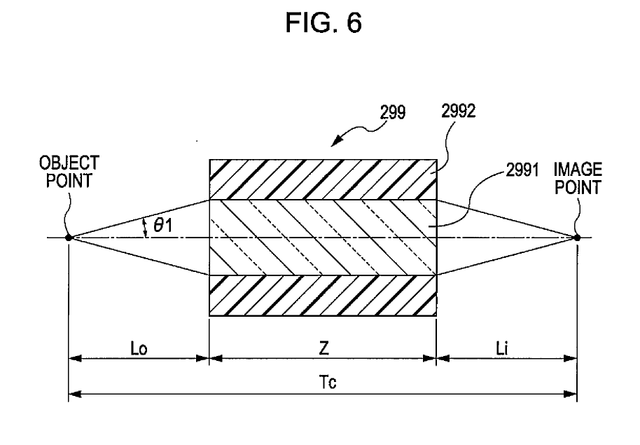

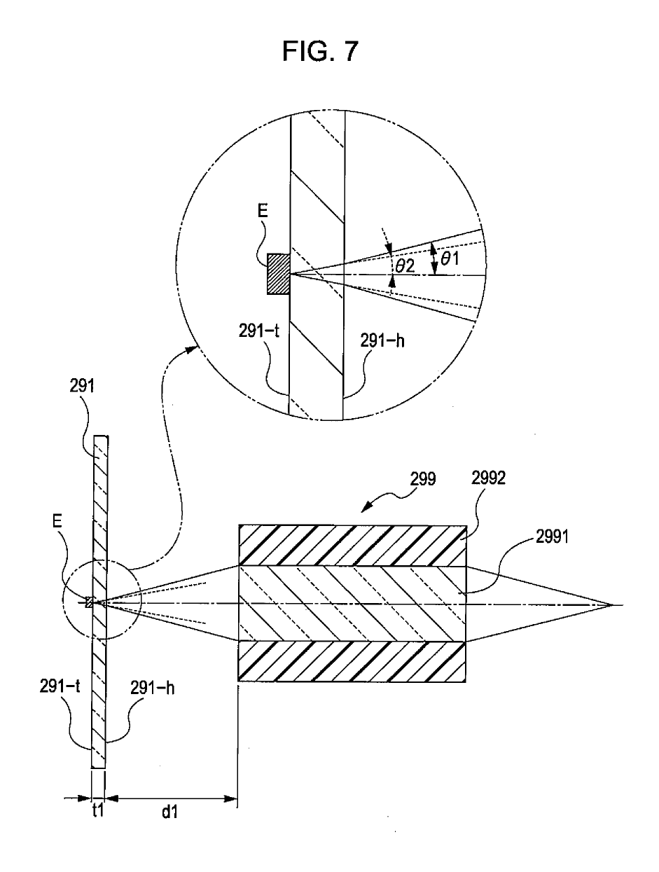

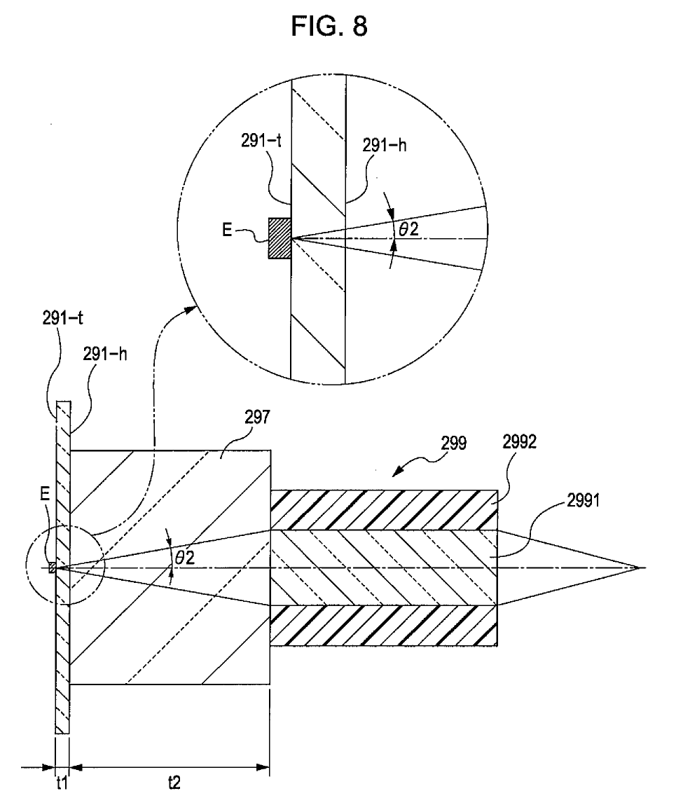

Next, an optical characteristic of the line head 29 is described. As described above, the glass member 297 is provided between the head substrate 291 and the rod lens array 299 in the line head 29 in this embodiment. However, in the following description, an optical characteristic (FIG. 6) of a rod lens array is shown first and then an optical characteristic (FIG. 7) of the line head 29 that is not equipped with the glass member 297 and an optical characteristic (FIG. 8) of the line head 29 that is equipped with the glass member 297 are described sequentially in order to enable a better understanding of the optical characteristic of the line head 29 of the present embodiment. FIG. 6 is a view showing the optical characteristic of a rod lens array, FIG. 7 is a view showing the optical characteristic of the line head that is not equipped with the glass member, and FIG. 8 is a view showing the optical characteristic of the line head that is equipped with the glass member.

As shown in FIG. 6, an object point side distance Lo and an image point side distance Li are almost the same. Accordingly, these distances and a conjugation length Tc of the rod lens array 299 are in the relationship shown in the following expression.

Lo≅Li=(Tc−Z)/2

Here, Z is the thickness of the rod lens array 299 in the lateral direction LTD and the direction which perpendicularly intersects the longitudinal direction LGD. Since the distances Lo and Li are distances measured in the air, distances Lo(n1) and Li(n1) measured in a medium having a refractive index n1 are as follows:

Lo(n1)=Lo×n1

Li(n1)=Li×n1

In the figure, θ1 is an angle (aperture angle) of light emitted from the object point and entering the rod lens array 299.

On the other hand, in the case in which the light-emitting elements E are provided on the back surface 291-t of the head substrate 291 as described, light from the light-emitting elements E penetrates through the head substrate 291 from the back surface 291-t to the front surface 291-h of the head substrate 291, and enters the rod lens array 299. The optical characteristic in the above case are described with reference to FIG. 7. A portion inside a circle in a dashed-two dotted line in an upper portion of FIG. 7 is an enlarged view of a portion inside a circle in a dashed-two dotted line in a lower portion of the same figure. θ1 is an angle of light after the light penetrates the head substrate 291 and θ2 is an angle (aperture angle) of light emitting from the light-emitting elements E. When the thickness of the head substrate 291 is t1, the refractive index of the head substrate 291 is ng, the thickness of the layer of air is d1, and the refractive index of the layer of air is about 1, the aperture angle θ2 is set to satisfy the following expression.

ng×sin(θ2)=sin(θ1)

t1/n291+d1=Lo

In addition, as in the present embodiment, the structure with the glass member 297 (FIG. 8) has the following optical characteristic. That is, when the refractive index of the head substrate 291 is about ng and almost the same as the refractive index of the glass member 297, the following expression is established.

t1+t2=Lo(ng)=Lo×ng

Here, t2 is a thickness of the glass member 297. The aperture angle θ2 is equal to the aperture angle θ2 of FIG. 7. That is, the aperture angle does not change depending on whether the gap between the head substrate 291 and the rod lens array 299 is filled with the glass member 297 or not.

Now, in the line head 29 equipped with the glass member 297, the following problem as described below arises according to a change in temperature. The linear expansion ratio of the rod lens array 299 is determined mainly depending on FRP. The linear expansion ratio of FRP is relatively small compared to other general resins, but considerably large compared to glass. For example, the linear expansion ratio of FRP is about 15×10⁻⁶(/° C.). On the other hand, the linear expansion ratio of alkali-free glass, which is the base substance of the head substrate 291, is about 3.5 to 3.8×10⁻⁶(/° C.), which is lower than the linear expansion ratio of the rod lens array 299. The glass member 297 made of general glass has a linear expansion ratio of about 9×10⁻⁶(/° C.). As described above, the linear expansion ratios of the rod lens array 299, the glass member 297, and the head substrate 291 are higher in this order. Further, these members are fixed to one another by an adhesive. Accordingly, when the temperature changes, the head substrate 291 does not expand or contract in the same way as the rod lens array 299 and the glass member 297. As a result, it sometimes happens that the head substrate 291 bends due to a phenomenon similar to the bimetal effect. Since the degree of the bending is may be close to 100 μm depending on the circumstances, it is difficult to make the imaging surface fit to the front surface of the photoconductor drum 21 over the entire area in the longitudinal direction LGD, and therefore it is feared that a good exposure operation and good image forming operation cannot be performed.

On the other hand, the line head 29 of the embodiment is structured such that the back surface 291-t of the head substrate 291 is supported by the frame 295 which is a rigid member. So, the frame 295 prevents the head substrate 291 from being deformed. Accordingly, bending of the head substrate 291 is suppressed regardless of expansion and contraction of the rod lens array 299. Therefore, good exposure can be attained. Further, it is possible to form a good image by using the line head 29.

In the present embodiment, the frame 295 includes a flat surface portion 2951 to which the back surface 291-t of the head substrate 291 is fixed and a bending portion 2952 which is curved and starts from the ends of the flat surface portion 2951. With this structure, rigidity of the frame 295 is enhanced and deformation of the head substrate 291 is suppressed, which results in good exposure.

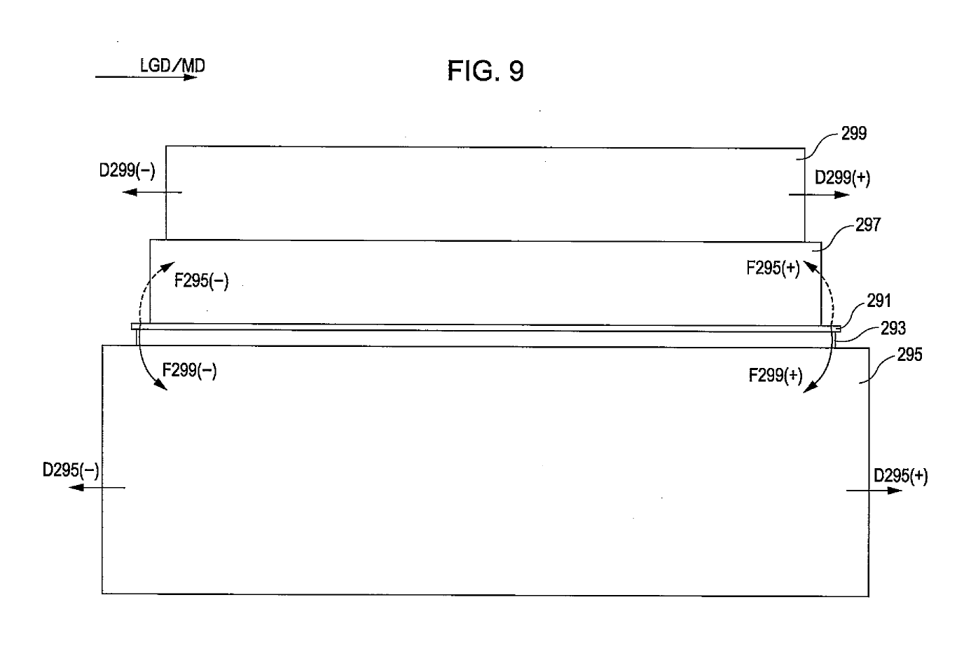

In the present embodiment, the linear expansion ratio of the frame 295 is larger than that of the head substrate 291. Accordingly, the following advantageous effects, which will be described below with reference to FIG. 9, can be further attained. FIG. 9 is an explanatory view for explaining the advantageous effect of the invention. As described above, the rod lens array 299 has a larger linear expansion ratio than the head substrate 291. Accordingly, in the case in which the temperature rises, the rod lens array 299 tends to extend in the longitudinal direction LGD (direction of arrow D299(+) D299(−) in FIG. 9) compared to the head substrate 291. As a result, the rod lens array 299 receives the force F299(+) and F299(−) which bends the head substrate 291. However, in the embodiment, the frame 295 has a larger linear expansion ratio than the head substrate 291. Accordingly, in the case in which the temperature rises, the frame 295 tends to extend in the longitudinal direction LGD (direction of arrows D295(+) and D295(−) in FIG. 9) like the rod lens array 299. As a result, the force F295(+) and F295(−) that resists against the force F299(+) and F299(−) applied to the head substrate 291 by the rod lens array 299 can be applied to the head substrate 291 by the frame 295. Accordingly, it becomes possible to attain good exposure by reliably suppressing the deformation of the head substrate 291.

In the embodiment, the linear expansion ratio of the frame 295 is about 16×10⁻⁶(/° C.), and the linear expansion ratio of the rod lens array 299 is about 15×10⁻⁶(/° C.). That is, the frame 295 and the rod lens array 299 have almost the same linear expansion ratio. Accordingly, the force F299(+) and F299(−) applied to the head substrate 291 by the rod lens array 299 and the force F295(+) and F295(−) applied to the substrate by the frame 295, that resists against the force F299(+) and F299(−), can be offset. Accordingly, it is possible to completely suppress the deformation of the head substrate 291. Thus, it is possible to attain very good exposure.

In the above embodiment, the glass member 297 is provided between the head substrate 291 and the rod lens array 299 and they are attached to each other by a transparent adhesive. The transparent adhesive has the same or almost the same refractive index as the glass member 297. Accordingly, the interface surfaces among members (head substrate 291, glass member 297, and rod lens array 299) actually do not exist, and reflection of light on the interface surfaces of the members is prevented. Accordingly, there can be suppression of loss of light attributable to reflection and formation of a ghost image which is formed as the reflected light, which is reflected from the front surface 291-h of the head substrate, is imaged by the rod lens array 299 after it is reflected again from the back surface 291-t of the head substrate.

In the above-described embodiment, the gap between the head substrate 291 and the rod lens array 299 can be precisely managed to correspond to the thickness of the glass member 297. In particular, since glass whose front and lower surfaces have been polisged is used as the glass member 297, the gap between the head substrate 291 and the rod lens array 299 can be further precisely managed. As a result, it is possible to perform a good exposure operation.

In the present embodiment, the glass member 297 is provided between the head substrate 291 and the rod lens array 299, and they are bonded to each other by a transparent adhesive. Accordingly, there is no space between the head substrate 291 and the rod lens array 299, where particles such as toner suspending inside the image forming device invade. Accordingly, blurring of the image attributable to the particles and loss of light can be inhibited. As a result, it is possible to perform a good exposure operation.

As described above, in the embodiment, the line head 29 corresponds to “exposure head” of the invention, the head substrate 291 corresponds to “substrate” of the invention, the back surface 291-t of the head substrate corresponds to “first substrate” of the invention, the front surface 291-h of the head substrate corresponds to “second surface” of the invention, the frame 295 corresponds to “support member” of the invention, and the glass member 297 corresponds to “light permeable member” of the invention.

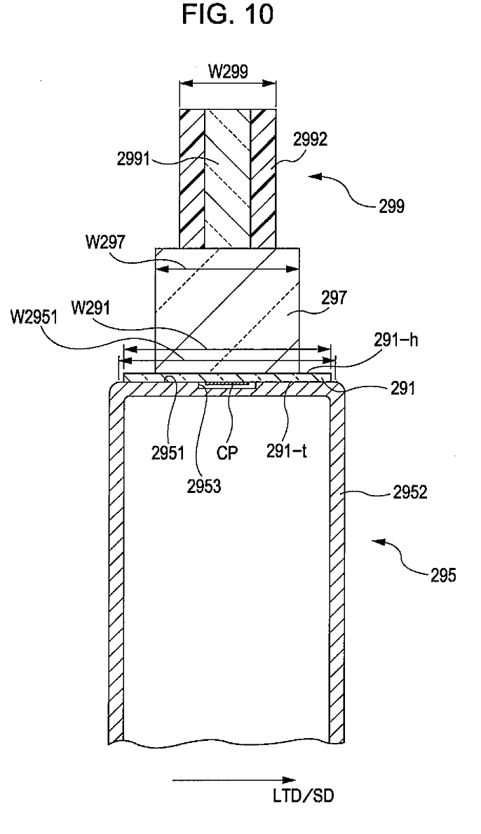

The invention is not limited to the above-described embodiment, and various changes and modifications may be made without departing from the spirit of the present invention. For example, in the above-described embodiment, the bottom emission type organic EL elements are used as the light-emitting elements. However, light-emitting diodes (LED) may be used as the light-emitting elements. FIG. 10 is a partial sectional view illustrating an LED used as the light-emitting element in the lateral direction. As shown in FIG. 10, an LED chip CP is mounted on the back surface 291-t of the head substrate 291. Light-emitting elements (not shown) are formed on the front surface of the LED chip CP (i.e., the surface facing the back surface 291-t of the head substrate 291). The frame 295 is provided with a space 2953 in which the LED chip CP can be placed therein. The frame 295 is directly bonded and fixed to the back surface 291-t of the head substrate, and the back surface 291-t of the head substrate is directly supported by the frame 295. Since other parts are the same in FIGS. 10 and 4, description thereon is omitted, referencing the parts with the same reference numbers. With the structure shown in FIG. 10, since deformation of the head substrate 291 is suppressed by the frame 295, it is possible to perform a good image forming operation.

In the above embodiment, the linear expansion ratio of the frame 295 is almost equal to the linear expansion ratio of the rod lens array 299. However, such a setting that the linear expansion ratios are almost equal to each other is not an absolute factor. That is, the linear expansion ratios of the members may be different from each other. Of course, the linear expansion ratios of the members may be equal to each other.

In the above embodiment, the frame 295 has the bending portion 2952. However, the curve portion 2952 is not absolutely necessary.

In the above embodiment, the plurality of light-emitting elements E are arranged in a zigzag form in three rows, but the arrangement of the light-emitting elements E is not limited thereto.

In the above embodiment, a dimensional relationship among members that constitute the line head 29 is shown, but this dimensional relationship is just an example. That is, the members can be configured to have a different dimensional relationship. For example, the head substrate 291 and the glass member 297 may have the following relationship in width.

W291=W297

The head substrate 291 and the sealing member 293 may have the following relationship in width.

W291<W293

In this case, it is easy to connect flexible printed circuits (FPC) boards to both ends of the head substrate in the lateral direction LTD.

What is claimed is:

1. An exposure head comprising:
a substrate through which light from a light-emitting element provided on a first surface of the substrate penetrates from the first surface to a second surface;
a rod lens array provided on the second surface of the substrate to image the light from the second surface;
a transparent member provided between the substrate and the rod lens array and fixed to the second surface of the substrate and the rod lens array; and
a support member that supports the first surface of the substrate.

2. The exposure head according to claim 1, wherein the light-emitting element is a bottom emission type organic electro-luminous (EL) element and the first surface of the substrate is supported by the support member via a sealing member for sealing the organic EL element.

3. The exposure head according to claim 1, wherein a linear expansion ratio of the substrate is smaller than that of the rod lens array.

4. The exposure head according to claim 3, wherein a linear expansion ratio of the support member is larger than that of the substrate.

5. The exposure head according to claim 4, wherein the linear expansion ratio of the rod lens array is equal to or almost equal to that of the support member.

6. The exposure head according to claim 1, wherein the support member includes a flat surface portion which supporting the second surface of the substrate and a curve portion curved to start from ends of the flat surface portion.

7. An image forming device comprising:
a latent image carrier;
an exposure head including a substrate through which light from a light-emitting element provided on a first surface of the substrate penetrates from the first surface to a second surface, a rod lens array provided on the second surface of the substrate to image the light from the second surface of the substrate onto the latent image carrier, a transparent member provided between the substrate and the rod lens array and fixed to the second surface of the substrate and the rod lens array, and a support member that supports the first surface of the substrate; and
a developing unit that develops a latent image formed on the latent image carrier by the exposure head with toner.
